(19) United States
(12) Patent Application Publication
(10) Pub. No.: US 2017/0178591 A1
(43) Pub. Date: Jun. 22, 2017

(54) SIGN DISPLAY APPARATUS AND METHOD FOR VEHICLE

(71) Applicant: HONDA MOTOR CO., LTD., Tokyo (JP)

(72) Inventors: Izumi Takatsudo, Wako-shi (JP); Yuji Yokochi, Wako-shi (JP); Shinnosuke Saito, Wako-shi (JP)

(73) Assignee: HONDA MOTOR CO., LTD., Tokyo (JP)

(21) Appl. No.: 15/388,222

(22) Filed: Dec. 22, 2016

(30) Foreign Application Priority Data
Dec. 22, 2015 (JP) 2015-249323

(51) Int. Cl. G09G 5/00; G09G 5/30; B60R 1/00; G09G 5/32; G09F 21/04; B60K 35/00

(52) U.S. Cl. CPC G09G 5/003; G09F 21/04; B60K 35/00; B60R 1/00; G09G 5/32; G09G 5/30; B60K 2350/352; B60K 2350/1076; B60K 2350/965; B60R 2300/301; B60R 2300/80

(57) ABSTRACT

When normal maximum speed information (first sign information of first maximum speed) in a first section and school-zone maximum speed information (second sign information of second maximum speed) in a second section overlapping the first section are detected by a camera, an MID displays the normal maximum speed information and the school-zone maximum speed information side by side according to an instruction of an ECU.

### CROSS REFERENCES TO RELATED APPLICATIONS

The present application claims priority under 35 U.S.C. §119 to Japanese Patent Application No. 2015-249323, filed Dec. 22, 2015, entitled “Sign Display Apparatus and Method for Vehicle.” The contents of this application are incorporated herein by reference in their entirety.

### BACKGROUND

1. Field

The present disclosure relates to a sign display apparatus and method for a vehicle that display sign information of a traffic sign or a road marking on a display unit in a vehicle.

2. Description of the Related Art

A vehicle in recent years is equipped with an apparatus that displays sign information on a display device in the vehicle. The sign information is detected from a traffic sign image captured by a vehicle-mounted camera. In some cases, road-to-vehicle communication is performed between wireless transmitters (a beacon, etc.) installed along a road and a vehicle-mounted wireless receiver. When the sign information is transmitted from the wireless transmitter, the vehicle is also able to detect the sign information by receiving a signal of the sign information with the wireless receiver. Further, the vehicle is also able to detect the sign information from map information of an apparatus (a car navigation apparatus, etc.) that detects the position of the vehicle.

Apparatuses that display sign information on display devices have been described in various literatures. For example, U.S. Pat. No. 7,961,080 describes an apparatus that displays sign information (maximum speed, etc.) in an image captured by a camera on a display device (FIG. 3). Japanese Unexamined Patent Application Publication No. 2009-110394 describes an apparatus that displays, when two or more signs are detected in sign information, the signs in the sign information in predetermined order on a display device in a vehicle (Claim 1 and paragraphs [0021] and [0043]).

The apparatus described in Japanese Unexamined Patent Application Publication No. 2009-110394 switches the signs in the sign information according to priority order set in advance and displays the sign information on the display device. For example, according to priority degrees, the apparatus switches and displays sign information of a maximum speed sign, sign information of a school, kindergarten, nursery school ahead sign, or the like, and sign information of a railroad crossing ahead sign (FIG. 6 of Japanese Unexamined Patent Application Publication No. 2009-110394).

Depending on a country or a region, maximum speed set in a school zone is changed according to a day of week or an hour. If the apparatus described in Japanese Unexamined Patent Application Publication No. 2009-110394 is set to prioritize the sign information of the school, kindergarten, nursery school ahead sign (also referred to as second sign information) over the sign information of the maximum speed sign (also referred to as first sign information), the apparatus displays the second sign on the display device instead of displaying the first sign information, even though the school or the like is closed. In this case, a driver cannot recognize the first sign information, that is, the maximum speed on the display device.

### SUMMARY

The present application describes a sign display apparatus and method for a vehicle that enable a driver to appropriately recognize maximum speed such as of a speed limit sign applied locally.

The present application describes a sign display apparatus for a vehicle including: a sign information detector that detects sign information of a traffic sign or a road marking ahead of a vehicle; a display device that displays the sign information detected by the sign information detector; and a control circuit that controls the display device. When the sign information detector detects first sign information concerning first maximum speed (a first speed limit) in a first section and second sign information concerning second maximum speed (a second speed limit) in a second section overlapping the first section, the display device displays the first sign information and the second sign information side by side according to an instruction of the control circuit.

As maximum speed set for a traveling road, besides normal maximum speed, there is maximum speed set for a specific area or the like. The normal maximum speed is referred to as first maximum speed and the maximum speed set for the specific area or the like is referred to as second maximum speed. As the second maximum speed, there is, for example, maximum speed set for a school zone. An effective section of the second maximum speed is set to overlap an effective section of the first maximum speed. If both of the first sign information of the first maximum speed and the second sign information of the second maximum speed are displayed as in the present application, a driver can recognize maximum speed information at every moment.

In the present application, the display device can also display the first sign information in a predetermined position when the sign information detector detects the first sign information without detecting the second sign information, and display the first sign information in the predetermined position and display the second sign information in a position laterally beside the predetermined position when the sign information detector detects both the first sign information and the second sign information. According to the present application, when the vehicle enters a section where the second maximum speed is set, it is possible to easily recognize the second sign information of the second maximum speed.

In the present application, when displaying the second sign information, the display device can also flash the display of the second sign information a predetermined number of times. According to the present application, the driver can easily recognize that the second sign information is set on the traveling road.

In the present application, the sign display apparatus for a vehicle can further include a speed detector that detects speed of the vehicle. When displaying the second sign information, the display device can also highlight the display of the second sign information to make the second sign information more visually prominent than the first sign information. Then, the display device can again highlight the second sign information when the speed detected by the speed detector is continuously higher than the second maximum speed indicated by the second sign information for a predetermined or longer time or a predetermined or longer distance. If the driver does not view the display device while the display device is displaying the second sign information, the driver may fail to recognize that the second sign information is set on the traveling road. According to the present application, the driver can more easily recognize that the second sign information is set on the traveling road.

In the present application, the sign display apparatus for a vehicle can further include an obstacle detector that detects an obstacle around the vehicle, the second sign information can also concern the second maximum speed applied to a school day or a commuting time of any one of a school, a kindergarten, and a nursery school (a school-zone speed limit applied locally and for a specific time period), and the display device can also highlight display of the second sign information to make the second sign information more visually prominent than the first sign information, when the obstacle detector detects a predetermined or more number of obstacles around the vehicle. At a time when the predetermined or more number of obstacles are present around the vehicle, the time is assumed to be a commuting time. According to the present application, it is possible to call the attention of the driver by highlighting the display of the second sign information.

In the present application, the sign display apparatus for a vehicle can further include at least one of a calendar day detector that detects a calendar day of a day when the vehicle is travelling and a time detector that detects time when the vehicle is traveling, the second sign information can also concern the second maximum speed in a school day or a commuting time of any one of a school, a kindergarten, and a nursery school. when the sign information detector detects the second sign information, the display device can also display the first sign information and the second sign information side by side if the calendar day detected by the calendar day detector falls into the school day or the time detected by the time detector falls into the commuting time, and display only the first sign information if the calendar day detected by the calendar day detection does not fall into the school day or the time detected by the time detector does not fall into the commuting time. According to the present application, it is possible to call the attention of the driver by displaying the first sign information and the second sign information side by side in the school day or the commuting time. Since only the first sign information is displayed in a day or time other than the school day or the commuting time, it is possible to appropriately display sign information to the driver.

The present application describes a sign display method for a vehicle including: detecting sign information of a traffic sign or a road marking ahead of a vehicle; and when first sign information of first maximum speed in a first section and second sign information of second maximum speed in a second section overlapping the first section are detected as the sign information, displaying the first sign information and the second sign information side by side. According to the present application, since both of the first sign information of the first maximum speed and the second sign information of the second maximum speed are displayed, a driver can recognize maximum speed information at every moment.

### BRIEF DESCRIPTION OF THE DRAWINGS

FIG. 1 is a simplified schematic view of an interior of a vehicle.

FIG. 2 is a block diagram of a sign display apparatus for a vehicle according to a first embodiment.

FIG. 3 is a flowchart of sign display processing performed in the first embodiment.

FIG. 4 is a transition chart of display corresponding to a change of a traveling position.

FIG. 5 is a block diagram of a sign display apparatus for a vehicle according to a second embodiment.

FIG. 6 is a flowchart of processing performed in the second embodiment.

FIG. 7 is an explanatory diagram served for explanation of highlighted display.

FIG. 8 is a block diagram of a sign display apparatus for a vehicle according to a third embodiment.

FIG. 9 is a flowchart of processing performed in the third embodiment.

FIG. 10 is a block diagram of a sign display apparatus for a vehicle according to a fourth embodiment.

FIG. 11 is a flowchart of processing performed in the fourth embodiment.

FIG. 12 is a block diagram of a sign display apparatus for a vehicle according to another embodiment.

### DESCRIPTION OF THE PREFERRED EMBODIMENTS

Sign display apparatuses for vehicles according to preferred embodiments are explained in detail below with reference to the accompanying drawings.

### 1. Overview of Embodiments

Sign display apparatuses for vehicles 50, 84, 94, and 100 explained below display normal maximum speed information (first sign information) and school-zone maximum speed information (second sign information) side by side on a display device. The “normal maximum speed information” means unconditional maximum speed information without a condition such as the school zone. Note that, in the following explanation, “maximum speed information” simply referred to means the “normal maximum speed information”. In general, a section (a second section) in which the school-zone maximum speed information is set overlaps a section (a first section) in which the normal maximum speed information is set. The sign display apparatuses for vehicles 50, 84, 94, and 100 display the normal maximum speed information and the school-zone maximum speed information side by side in the second section overlapping the first section.

### 2. First Embodiment

### 2-1. Interior of a Vehicle 10

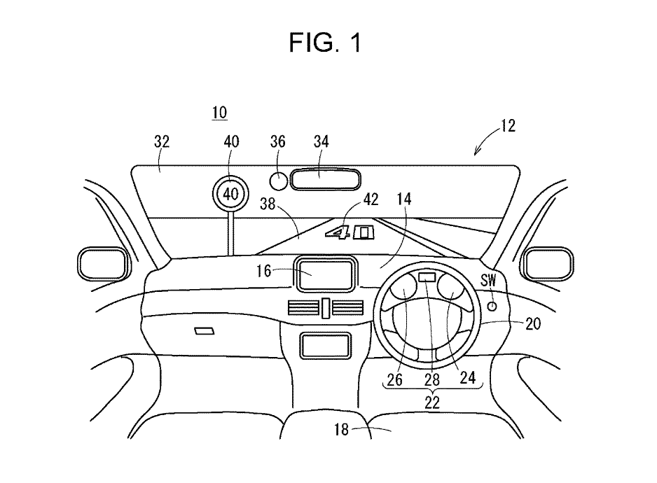

The sign display apparatus for a vehicle 50 is mounted on a vehicle 10. To begin with, the interior of the vehicle 10 is described by using FIG. 1. In FIG. 1, the interior of the vehicle 10 is depicted in a schematic view for simplification of explanation. In a vehicle interior 12 of the vehicle 10, a car navigation apparatus 16 is provided substantially in the center in the vehicle width direction of a dashboard 14. A meter panel 22 is provided on the right side in the vehicle width direction of the dash board 14 and in the front of a driver's seat 18 and a steering wheel 20.

The meter panel 22 includes, for example, a speed meter 24 disposed on the right side, a tachometer 26 disposed on the left side, and a multi-information display (MID) 28 disposed in the center. The MID 28 displays images indicating various kinds of information such as sign information and vehicle information (vehicle speed, a yaw rate, fuel efficiency, a traveling time, various traveling distances, a drivable distance, a traveling mode, etc.). Display content of the MID 28 can be switched according to operation of a changeover switch SW1 provided in the vehicle interior 12.

A camera 36 is provided on the inner side of a windshield 32 and near a rearview mirror 34. The camera 36 is attached to face the front of the vehicle 10. As the camera 36, various cameras (a monocular camera, a stereo camera, an infrared camera, etc.) can be used. The camera 36 images the front of the vehicle 10 always or in every predetermined time and also images a traffic sign 40 and/or a road marking 42 indicating sign information at this point.

### 2-2. Configuration of the Sign Display Apparatus for a Vehicle 50

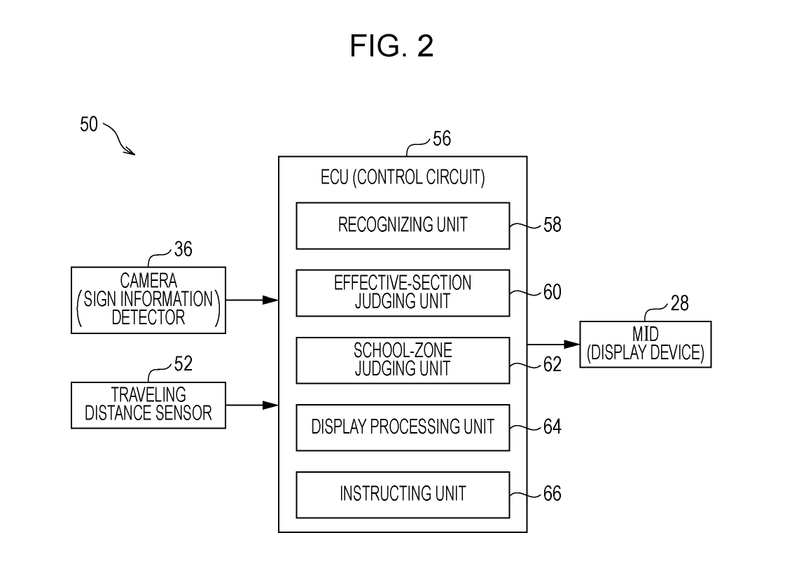

The configuration of the sign display apparatus for a vehicle 50 according to the first embodiment is explained with reference to FIG. 2. The sign display apparatus for a vehicle 50 includes, besides the camera 36 and the MID 28 shown in FIG. 1, a traveling distance sensor 52 that measures a traveling distance of the vehicle 10 and an ECU 56 that performs display control of sign information. The camera 36, the traveling distance sensor 52, the ECU 56, and the MID 28 are a part of components of a vehicle-mounted network and are capable of communicating with one another via the network.

The ECU 56 is a control circuit including a microcomputer and includes a CPU (central processing unit), a ROM (including an EEPROM), a RAM (random access memory), and input and output devices such as an A/D converter and a D/A converter. The CPU reads out and executes computer programs recorded in the ROM, whereby the ECU 56 functions as various function realizing units. In this embodiment, the ECU 56 executes the computer programs to thereby function as a recognizing unit 58, an effective-section judging unit 60, a school-zone judging unit 62, a display processing unit 64, and an instructing unit 66. The ECU 56 may be divided into a plurality of units or may be integrated with other ECUs. Note that the ECU 56 can also be realized by other hardware.

The recognizing unit 58 is configured to process an image of the front of the vehicle 10 captured by the camera 36 and recognize the sign information indicated by the traffic sign 40 and the road marking 42. The recognizing unit 58 is capable of performing publicly-known traffic sign recognition processing such as pattern matching. For example, the recognizing unit 58 is configured to recognize signs (the traffic sign 40 and the road marking 42) out of the image of the front of the vehicle 10 captured by the camera 36, remove noise of a recognized image (an image of the traffic sign 40 and the road marking 42), and recognize a type of the sign information.

The effective-section judging unit 60 is configured to judge whether the vehicle 10 is traveling an effective section of the sign information recognized by the recognizing unit 58. For example, the traffic sign 40 set on a traveling road 38 is added with auxiliary sign indicating an effective section of the traffic sign 40. The effective-section judging unit 60 judges based on information of the auxiliary sign recognized by the recognizing unit 58 whether the vehicle 10 is traveling the effective section of the sign information indicated by the traffic sign 40. Concerning the traffic sign 40 not added with the auxiliary information, the effective-section judging unit 60 judges based on a fixed distance starting from the traffic sign 40 and a traveling distance detected by the traveling distance sensor 52 whether the vehicle 10 is traveling in the effective section of the sign information.

The school-zone judging unit 62 is configured to judge whether the traveling road 38 is in a school zone. Depending on a region, the traffic sign 40 or the road marking 42 indicating the school zone and the traffic sign 40 or the road marking 42 indicating maximum speed (second maximum speed) of the school zone are set at a start point of the school zone. The traffic sign 40 or the road marking 42 indicating the end of the school zone is set at an end point of the school zone. The school-zone judging unit 62 judges based on the traffic sign 40 or the road marking 42 concerning the school zone recognized by the recognizing unit 58 whether the traveling road 38 is in the school zone. For example, when the school-zone maximum speed information is recognized by the recognizing unit 58, until sign information indicating the end of the school zone is recognized by the recognizing unit 58, the school-zone judging unit 62 judges that the traveling road 38 is in the school zone. Alternatively, when the school-zone maximum speed information is recognized by the recognizing unit 58 and it is judged by the effective-section judging unit 60 that the vehicle 10 is traveling in the effective section of the maximum speed information, the effective-section judging unit 60 judges that the traveling road 38 is in the school zone.

The display processing unit 64 is configured to perform control of display and hiding of the normal maximum speed information and the school-zone maximum speed information in the sign information. The instructing unit 66 is configured to receive a processing result of the display processing unit 64 and output a display instruction and a hiding instruction for the sign information to the MID 28.

### 2-3. Sign Display Processing

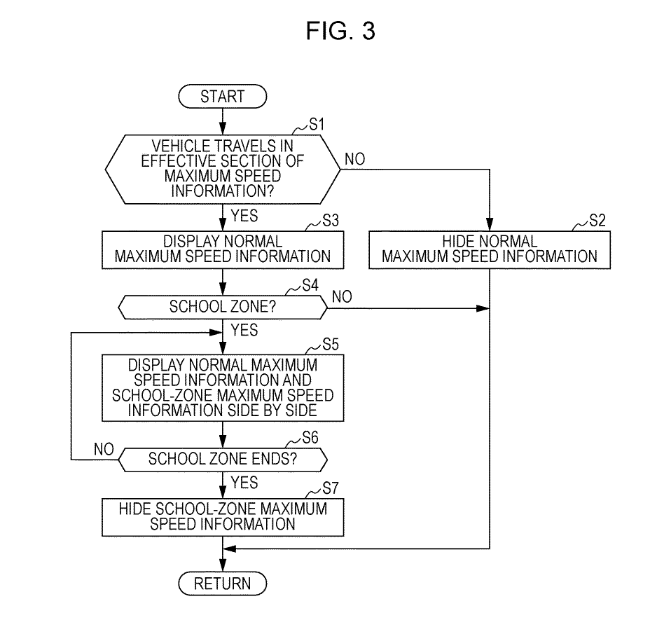

Sign display processing performed in the sign display apparatus for a vehicle 50 is explained with reference to FIG. 3. A series of processing explained below may be periodically performed or may be performed at predetermined timing, for example, timing when sign information is detected. It is assumed that the camera 36 images the front of the vehicle 10 always or in every predetermined time and detects various kinds of sign information.

In step S1, it is judged whether a traveling position of the vehicle 10 is within the effective section of the maximum speed information. The effective-section judging unit 60 judges whether the traveling position of the vehicle 10 is within an effective section of the latest maximum speed information. When the traveling position of the vehicle 10 is within the effective section of the maximum speed information (YES in step S1), the processing shifts to processing in step S3. On the other hand, when the traveling position of the vehicle 10 is not within the effective section of the maximum speed information (NO in step S1), the processing shifts to processing in step S2.

In step S2, the MID 28 hides the normal maximum speed information. At this point, the display processing unit 64 performs, based on a discrimination result of the effective-section judging unit 60, display control for setting the maximum speed information to a hidden state. The instructing unit 66 outputs, based on the display control of the display processing unit 64, a hiding instruction to the MID 28. The MID 28 hides the maximum speed information according to the hiding instruction. The processing returns to step S1 and new processing is executed.

In step S3, the MID 28 displays the normal maximum speed information. The display processing unit 64 performs, based on the discrimination result of the effective-section judging unit 60, display control for setting the maximum speed information to a displayed state. The instructing unit 66 outputs, based on the display control of the display processing unit 64, a display instruction to the MID 28. The MID 28 displays the maximum speed information in a predetermined position according to the display instruction.

In step S4, it is judged whether a traveling position of the vehicle 10 is in the school zone. When the camera 36 is imaging (detecting) the school-zone maximum speed information other than the normal maximum speed information, the recognizing unit 58 recognizes both the kinds of maximum speed information. When the school-zone maximum speed information is recognized and the sign information indicating the end of the school zone is not recognized, the school-zone judging unit 62 judges that the traveling position of the vehicle 10 is in the school zone. Alternatively, when the school-zone maximum speed information is recognized and the traveling distance of the vehicle 10 is within the fixed distance from the start point of the school zone, the school-zone judging unit 62 judges that the traveling position of the vehicle 10 is in the school zone. When the traveling position of the vehicle 10 is in the school zone (YES in step S4), the processing shifts to processing in step S5. On the other hand, when the traveling position of the vehicle 10 is not in the school zone (NO in step S4), the processing returns to step S1 and new processing is executed.

In step S5, the MID 28 displays the normal maximum speed information and the school-zone maximum speed information side by side. At this point, the display processing unit 64 performs, based on the discrimination result of the effective-section judging unit 60, display control for setting the school-zone maximum speed information to the displayed state. The instructing unit 66 outputs, based on the display control of the display processing unit 64, a display instruction to the MID 28. According to the display instruction, the MID 28 displays the normal maximum speed information in a predetermined position and displays the school-zone maximum speed information in a position laterally beside the predetermined position. In this way, the normal maximum speed information and the school-zone maximum speed information are displayed side by side.

In step S6, it is judged whether the school zone ends. When the sign information indicating the end of the school zone is recognized, the school-zone judging unit 62 judges that the school zone ends. Alternatively, when the traveling distance of the vehicle 10 exceeds the fixed distance from the start point of the school zone, the school-zone judging unit 62 judges that the school zone ends. When the school zone ends (YES in step S6), the processing shifts to processing in step S7. On the other hand, when the school zone does not end (NO in step S6), the processing in step S5 and subsequent steps is repeatedly performed.

In step S7, the MID 28 hides the school-zone maximum speed information. At this point, the display processing unit 64 performs, based on the discrimination result of the school-zone judging unit 62, display control for setting the school-zone maximum speed information to the hidden state. The instructing unit 66 outputs, based on the display control of the display processing unit 64, a hiding instruction to the MID 28. The MID 28 hides the school-zone maximum speed information according to the hiding instruction. On the other hand, the MID 28 displays the normal maximum speed information as it is.

### 2-4. Specific Example

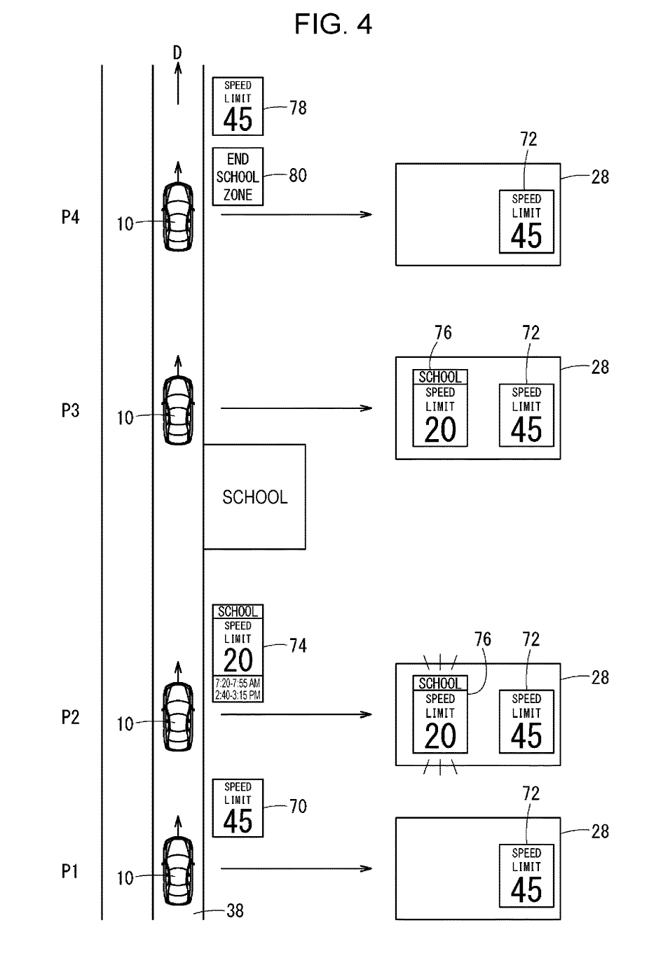

A specific transition example of display is explained with reference to FIG. 4. Note that FIG. 4 shows a state in which the vehicle 10 is traveling in a D direction on the traveling road 38 in the United States. Road signs 70, 74, 78, and 80 set on the traveling road 38 are signs in the United States.

In a traveling position P1, the camera 36 of the vehicle 10 images the traffic sign 70 indicating maximum speed. At this point, the MID 28 displays an image 72 indicating the maximum speed information in a predetermined position according to the display instruction outputted from the instructing unit 66 (step S3 in FIG. 3). Since the traveling position P1 is not in the school zone, the MID 28 hides the school-zone maximum speed information (NO in step S4 in FIG. 3).

In a traveling position P2, the camera 36 of the vehicle 10 images the traffic sign 74 indicating the school-zone maximum speed. At this point, the MID 28 displays the image 72 indicating the maximum speed information in the predetermined position according to the display instruction outputted from the instructing unit 66 (step S3 in FIG. 3). Further, the MID 28 displays an image 76 indicating the school-zone maximum speed information in the position laterally beside the predetermined position according to the display instruction outputted from the instructing unit 66 (step S5 in FIG. 3). The MID 28 flashes the image 76 a predetermined number of times when displaying the image 76. The MID 28 flashes the image 76 twice.

In a traveling position P3, the vehicle 10 travels in the school zone. At this point, the MID 28 displays the image 72 indicating the maximum speed information in the predetermined position and displays the image 76 indicating the school-zone maximum speed information in the position laterally beside the predetermined position according to the display instruction outputted from the instructing unit 66 (step S5 in FIG. 3).

In a traveling position P4, the camera 36 of the vehicle 10 images the traffic sign 78 indicating the maximum speed and the traffic sign 80 indicating the end of the school zone. At this point, the MID 28 hides the image 76 indicating the school-zone maximum speed information according to the hiding instruction outputted from the instructing unit 66 (step S7 in FIG. 3). Further, the MID 28 displays the image 72 indicating the maximum speed information in the predetermined position according to the display instruction outputted from the instructing unit 66 (step S3 in FIG. 3).

### 2-5. Summary of the First Embodiment

The sign display apparatus for a vehicle 50 according to the first embodiment includes the camera 36 (the sign information detector) that detects the sign information of the traffic sign 40 or the road marking 42 in the front of the vehicle 10, the MID 28 (the display device) that displays the sign information detected by the camera 36, and the ECU 56 (the control circuit) that controls the MID 28. When the normal maximum speed information (the first sign information concerning the first maximum speed) in the first section and the school-zone maximum speed information (the second sign information concerning the second maximum speed) in the second section overlapping the first section are detected by the camera 36, the MID 28 displays the normal maximum speed information and the school-zone maximum speed information side by side according to the instruction of the ECU 56. As in the first embodiment, since both of the normal maximum speed information and the school-zone maximum speed information are displayed, the driver can recognize the maximum speed information at every moment.

When the normal maximum speed information is detected and the school-zone maximum speed information is not detected by the camera 36, the MID 28 displays the first sign information in the predetermined position. When the normal maximum speed information and the school-zone maximum speed information are detected by the camera 36, the MID 28 displays the normal maximum speed information in the predetermined position and displays the school-zone maximum speed information in the laterally beside the predetermined position. According to the first embodiment, when the vehicle 10 enters the section in which the second maximum speed is set, it is possible to easily recognize the second sign information concerning the second maximum speed.

The MID 28 flashes display of the school-zone maximum speed information the predetermined number of times when displaying the school-zone maximum speed information. Consequently, the driver can easily recognize that the school-zone maximum speed information is set for the traveling road 38.

In a sign-for-vehicle display method according to the first embodiment, the sign information of the traffic sign 40 or the road marking 42 in the front of the vehicle 10 is detected. When the normal maximum speed information (the first sign information concerning the first maximum speed) in the first section and the school-zone maximum speed information (the second sign information concerning the second maximum speed) in the second section overlapping the first section are detected as the sign information, the normal maximum speed information and the school-zone maximum speed information are displayed side by side (step S5 in FIG. 3). Since both of the normal maximum speed information and the school-zone maximum speed information are displayed, the driver can recognize the maximum speed information at every moment.

Note that, according to the first embodiment, even in a day of week (a holiday) or time (evening) when the school-zone maximum speed information is not applied, the normal maximum speed information and the school-zone maximum speed information are displayed side by side on the display device 28. There are children acting in the school even in a holiday or in the evening. The children pass the school zone. According to the first embodiment, it is possible to call the attention of the driver to the children.

### 3. Second Embodiment

### 3-1. Configuration of the Sign Display Apparatus for a Vehicle 84

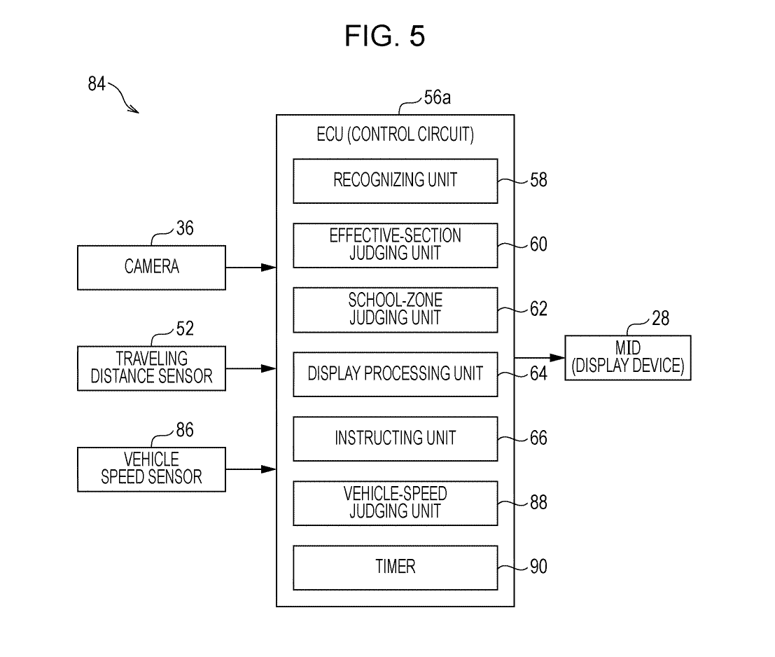

The configuration of the sign display apparatus for a vehicle 84 according to a second embodiment is explained with reference to FIG. 5. In the sign display apparatus for a vehicle 84, functions are added to the sign display apparatus for a vehicle 50 shown in FIG. 2. Among components of the sign display apparatus for a vehicle 84, components same as the components of the sign display apparatus for a vehicle 50 are denoted by the same reference numerals and signs and explanation of the components is omitted. In the second embodiment, when vehicle speed exceeds school-zone maximum speed, the sign display apparatus for a vehicle 84 alarms a driver.

The sign display apparatus for a vehicle 84 includes a vehicle speed sensor 86. The vehicle speed sensor 86 detects vehicle speed of the vehicle 10 and outputs a vehicle speed signal indicating the vehicle speed to an ECU 56a. The ECU 56a includes a vehicle-speed judging unit 88. The vehicle-speed judging unit 88 is configured to judge whether the vehicle speed of the vehicle 10 exceeds the school-zone maximum speed. The ECU 56a includes a timer 90 that measures time.

### 3-2. Processing Performed in the Sign Display Apparatus for a Vehicle 84

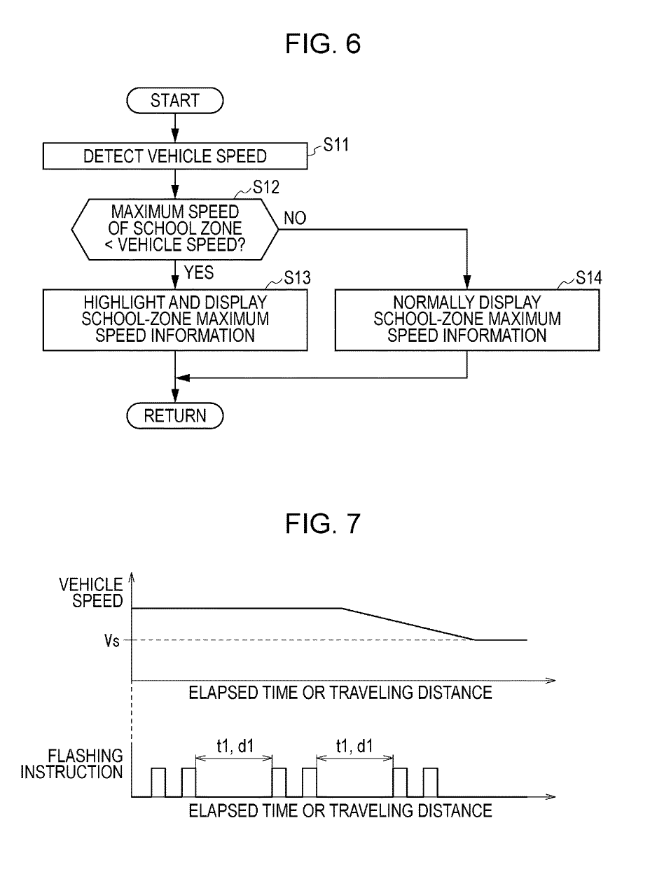

Processing performed in the sign display apparatus for a vehicle 84 is explained with reference to FIG. 6. Like the sign display apparatus for a vehicle 50 according to the first embodiment, the sign display apparatus for a vehicle 84 performs the sign display processing shown in FIG. 3. Further, the sign display apparatus for a vehicle 84 performs the processing shown in FIG. 6 in parallel to the processing in step S5 in FIG. 3.

In step S11, the vehicle speed sensor 86 detects vehicle speed of the vehicle 10.

In step S12, it is judged whether the vehicle speed exceeds the school-zone maximum speed. The vehicle-speed judging unit 88 compares the vehicle speed detected by the vehicle speed sensor 86 and the school-zone maximum speed recognized by the recognizing unit 58. When the vehicle speed exceeds the school-zone maximum speed (YES in step S12), the processing shifts to processing in step S13. On the other hand, when the vehicle speed is equal to or lower than the school-zone maximum speed (NO in step S12), the processing shifts to processing in step S14.

In step S13, the MID 28 highlights display of the school-zone maximum speed information. By highlighting the display of the school-zone maximum speed information, the MID 28 informs the driver that the vehicle speed exceeds the school-zone maximum speed. The MID 28 flashes the school-zone maximum speed information in every predetermined time or predetermined distance. For example, as shown in FIG. 7, the instructing unit 66 outputs a flashing instruction to the MID 28 every time a measured time of the timer 90 reaches a predetermined time t1 or a measured distance of the traveling distance sensor 52 reaches a predetermined distance dl. The flashing instruction is outputted while the vehicle speed exceeds school-zone maximum speed Vs. The MID 28 flashes the school-zone maximum speed a predetermined number of times according to the flashing instruction. The MID 28 flashes the school-zone maximum speed twice. Note that the display may be highlighted with the luminance increased or with a display color changed.

In step S14, the MID 28 normally displays the school-zone maximum speed information.

### 3-3. Summary of the Second Embodiment

With the sign display apparatus for a vehicle 84 according to the second embodiment, it is possible to obtain effects equivalent to the effects of the sign display apparatus for a vehicle 50 according to the first embodiment.

The sign display apparatus for a vehicle 84 according to the second embodiment includes the vehicle speed sensor 86 (the speed detector) that detects the speed of the vehicle 10. In displaying the school-zone maximum speed (the second sign information), the MID 28 (the display device) highlights the display of the school-zone maximum speed information to make the school-zone maximum speed information more visually prominent than the normal sign information (the first sign information). Further, when the speed detected by the vehicle speed sensor 86 is continuously higher than the maximum speed Vs (the second maximum speed) indicated by the school-zone maximum speed information for the predetermined time t1 or longer or the predetermined distance dl or longer, the MID 28 highlights the display again.

If the driver does not view the MID 28 while the MID 28 is displaying the school-zone maximum speed information, the driver may fail to recognize that the school-zone maximum speed information is set for the traveling road 38. According to the second embodiment, the driver can more easily recognize that the school-zone maximum speed information is set for the traveling road 38.

### 4. Third Embodiment

### 4-1. Configuration of the Sign Display Apparatus for a Vehicle 94

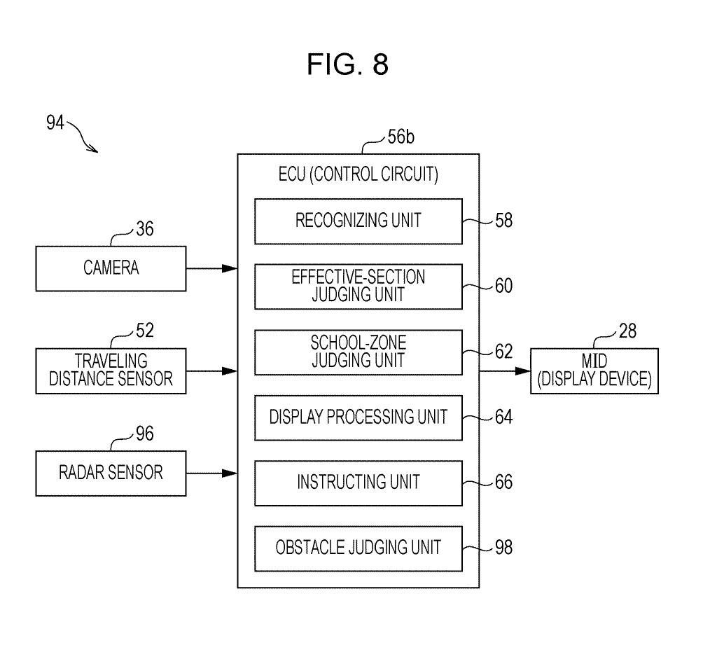

The configuration of the sign display apparatus for a vehicle 94 according to the third embodiment is explained with reference to FIG. 8. In the sign display apparatus for a vehicle 94, functions are added to the sign display apparatus for a vehicle 50 shown in FIG. 2. Among components of the sign display apparatus for a vehicle 94, components same as the components of the sign display apparatus for a vehicle 50 are denoted by the same reference numerals and signs and explanation of the components is omitted. Since children pass a school zone when going to a school, a kindergarten, a nursery school, or the like, obstacles (children) increase around the traveling road 38 in a commuting time. Therefore, a driver is requested to carefully drive the vehicle 10. In the third embodiment, the sign display apparatus for a vehicle 94 informs the driver that a predetermined or more number of obstacles (children) are present around the vehicle 10 and calls the attention of the driver. Note that, in this specification, besides going to the school, going to the kindergarten and the nursery school is also referred to as going to the school.

A radar sensor 96 detects an obstacle ahead and detects the distance to the obstacle. The radar sensor 96 is provided to face forward in a front portion of the vehicle 10, for example, in a front grille. As the radar sensor 96, various radars (a millimeter wave radar, a micro wave radar, a laser radar, etc.) can be used. It is also possible to use a fusion sensor that integrates information obtained from the camera 36 and information obtained from the radar sensor 96. In order to detect obstacles on the side and the rear of the vehicle 10, other radar sensors directed to the side and the rear of the vehicle 10 may be provided. The radar sensor 96 outputs a signal including information of the number of detected obstacles to an ECU 56b. The ECU 56b includes an obstacle judging unit 98. The obstacle judging unit 98 is configured to judge whether a predetermined or more number of obstacles are present around the vehicle 10.

### 4-2. Processing Performed in the Sign Display Apparatus for a Vehicle 94

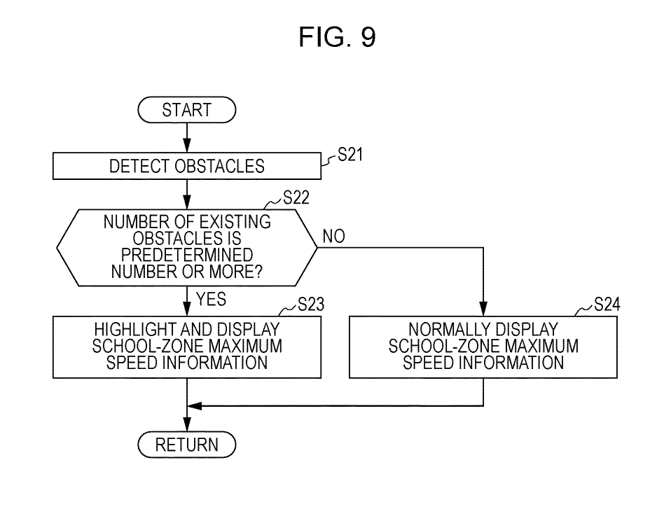

Processing performed in the sign display apparatus for a vehicle 94 is explained with reference to FIG. 9. Like the sign display apparatus for a vehicle 50 according to the first embodiment, the sign display apparatus for a vehicle 94 performs the sign display processing shown in FIG. 3. Further, the sign display apparatus for a vehicle 94 performs processing shown in FIG. 9 in parallel to the processing in step S5 in FIG. 3.

In step S21, obstacles are detected. The radar sensor 96 detects obstacles around the vehicle 10.

In step S22, it is judged whether the number of existing obstacles is a predetermined or more number. The obstacle judging unit 98 judges whether the number of obstacles detected by the radar sensor 96 is equal to or larger than the predetermined number. When the number of obstacles is the predetermined or more number (YES in step S22), the processing shifts to processing in step S23. On the other hand, when the number of obstacles is smaller than the predetermined number (NO in step S22), the processing shifts to processing in step S24.

In step S23, the MID 28 highlights and displays the school-zone maximum speed information. This processing is the same as the processing in step S13 shown in FIG. 6.

In step S24, the MID 28 normally displays the school-zone maximum speed information. This processing is the same as the processing in step S14 shown in FIG. 6.

### 4-3. Summary of the Third Embodiment

With the sign display apparatus for a vehicle 94 according to the third embodiment, it is possible to obtain effects equivalent to the effects of the sign display apparatus for a vehicle 50 according to the first embodiment.

The sign display apparatus for a vehicle 94 according to the third embodiment includes the radar sensor 96 (the obstacle detector) that detects obstacles around the vehicle 10. The school-zone maximum speed information (the second sign information) concerns the maximum speed (the second maximum speed) applied to a school day or a commuting time of any one of a school, a kindergarten, and a nursery school. When the radar sensor 96 detects the predetermined or more number of obstacles around the vehicle 10, the MID 28 (the display device) highlights display of the school-zone maximum speed information to make the school-zone maximum speed information more visually prominent than the normal maximum speed information. At a time when the predetermined or more number of obstacles are present around the vehicle 10, the time is assumed to be a commuting time. According to the third embodiment, since the display of the school-zone maximum speed information is highlighted, it is possible to call the attention of the driver.

### 5. Fourth Embodiment

### 5-1. Configuration of the Sign Display Apparatus for a Vehicle 100

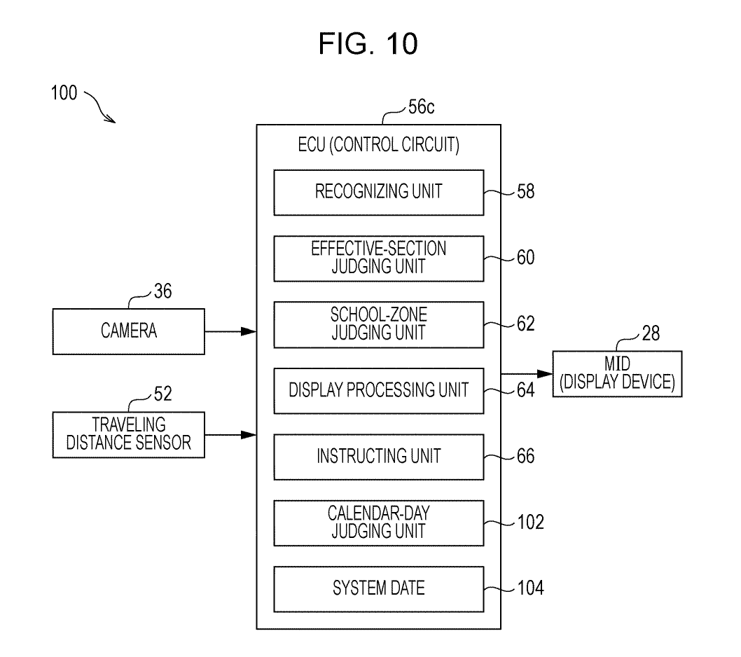

The configuration of the sign display apparatus for a vehicle 100 according to a fourth embodiment is explained with reference to FIG. 10. In the sign display apparatus for a vehicle 100, functions are added to the sign display apparatus for a vehicle 50 shown in FIG. 2. Among components of the sign display apparatus for a vehicle 100, components same as the components of the sign display apparatus for a vehicle 50 are denoted by the same reference numerals and signs and explanation of the components is omitted. In the fourth embodiment, if a day or time when the vehicle 10 is traveling is a calendar day or a time to which school-zone maximum speed information is to be applied, the school-zone maximum speed information is displayed.

An ECU 56c includes a calendar-day judging unit 102 and a system date 104. The calendar-day judging unit 102 is configured to judge whether a day or time when the vehicle 10 is traveling is a calendar day or time to which the school-zone maximum speed is applied. The system date 104 retains an actual date and actual time.

### 5-2. Processing Performed in the Sign Display Apparatus for a Vehicle 100

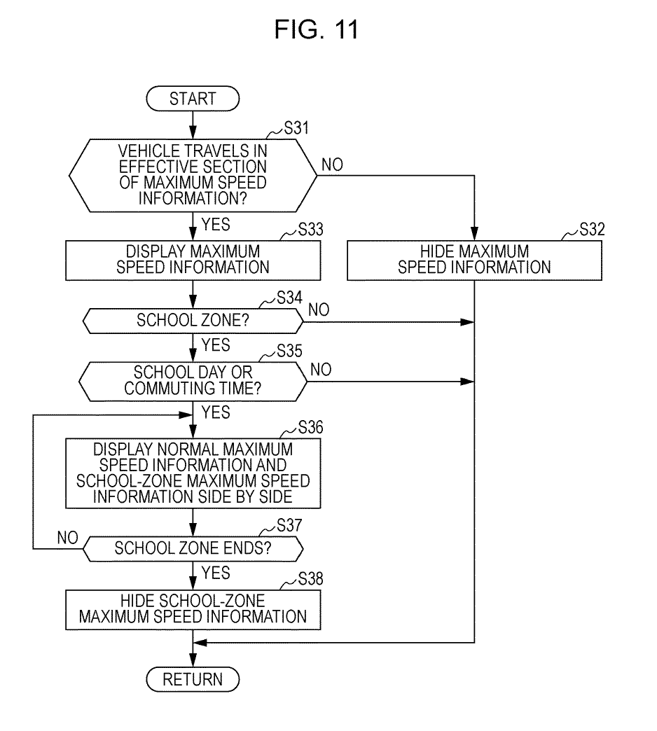

Processing performed in the sign display apparatus for a vehicle 100 is explained with reference to FIG. 11. Processing in steps S31 to S34 and steps S36 to S38 shown in FIG. 11 is the same with the processing in steps S1 to S7 shown in FIG. 3. Therefore, explanation of the processing being the same with the processing shown in FIG. 3 is omitted. Processing peculiar to the fourth embodiment is discrimination in step S35. In the following explanation, the processing in step S35 is mainly explained.

A sign of a calendar day (a day of week, etc.), a time, or the like equivalent to a school day or a commuting time is added to a sign indicating the school-zone maximum speed information. The school-zone maximum speed is applied to the calendar day or the time. The recognizing unit 58 recognizes the calendar day or the time, that is, the school day or the commuting time indicated by the sign.

In step S35, it is judged whether a day or time when the vehicle 10 is traveling is a school day or a commuting time. The calendar-day judging unit 102 judges whether the day or the time when the vehicle 10 is traveling falls into the school day or the commuting time. As the day or the time when the vehicle 10 is traveling, the actual day or the actual time retained by the system date 104 is used. If the day or the time when the vehicle 10 is traveling falls into the school day or the commuting time (YES in step S35), the processing shifts to processing in step S36. If the day or the time when the vehicle 10 is traveling does not fall into the school day or the commuting time (NO in step S35), the processing returns to step S31 and new processing is executed.

### 5-3. Summary of the Fourth Embodiment

With the sign display apparatus for a vehicle 100 according to the fourth embodiment, it is possible to obtain effects equivalent to the effects of the sign display apparatus for a vehicle 50 according to the first embodiment.

The sign display apparatus for a vehicle 100 according to the fourth embodiment includes the system date 104 (the calendar-day detector or the time detector) that detects a calendar day of a day when the vehicle 10 is traveling and detects time when the vehicle 10 is traveling. The school-zone maximum speed information concerns the maximum speed (the second maximum speed) in the school day or the commuting time of any one of a school, a kindergarten, and a nursery school. When the school-zone maximum speed information is detected by the camera 36 (the sign information detector), the MID 28 (the display device) displays the normal maximum speed information and the school-zone maximum speed information side by side when the calendar day detected by the system date 104 falls into the school day or the time detected by the system date 104 falls into the commuting time. The MID 28 displays only the normal maximum speed information if the calendar day detected by the system date 104 does not fall into the school day or the time detected by the system date 104 does not fall into the commuting time. According to the fourth embodiment, since the normal maximum speed information and the school-zone maximum speed information are displayed side by side in the school day or the commuting time, it is possible to call the attention of the driver. Since only the normal maximum speed information is displayed in a day or an hour other than the school day or the commuting time, it is possible to appropriately display the sign information to the driver.

### 6. Other Embodiments

### 6-1. Sign Information Detector

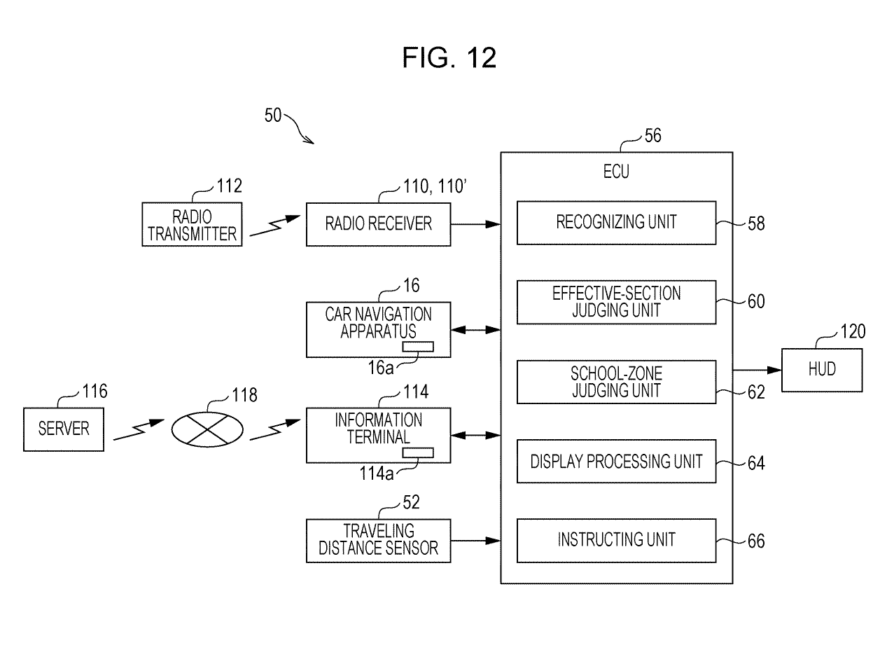

In the first to fourth embodiments, the camera 36 is used as the sign information detector. However, other apparatuses can also be used instead of the camera 36. For example, as shown in FIG. 12, at least one of a wireless receiver 110, the car navigation apparatus 16, and an information terminal 114 can also be used.

The wireless receiver 110 receives a signal transmitted from the outside of the vehicle 10. When the traveling road 38 is a main road (including an expressway), a plurality of wireless transmitters 112, for example, optical beacons that transmit traffic information (including sign information) with light and radio wave beacons that transmit traffic information (including sign information) with a radio wave are set along the traveling road 38. The wireless transmitters 112 are managed by a not-shown information managing unit. A sign information providing system is constructed by the information managing unit and the wireless transmitters 112. As such a system, there is, for example, a vehicle information and communication system (VICS) (registered trademark). When the wireless transmitter 112 is the optical beacon, a signal receiving area is several meters in front of or behind a point just under the beacon. When the wireless transmitter 112 is the radio wave beacon, a signal receiving area is several ten meters in front of or behind a point just under the beacon. The wireless receiver 110 receives a signal of traffic information transmitted from the wireless transmitter 112 in the receiving area. Note that a sign display apparatus for a vehicle may include a wireless receiver 110′ that performs vehicle-to-vehicle communication instead of or in addition to the road-to-vehicle communication.

The car navigation device 16 reads map information from a storage medium (a CD, a DVD-ROM, etc.) and stores the map information in a storage device on the inside. The car navigation apparatus 16 includes a function of positioning a traveling position of the vehicle 10. The car navigation apparatus 16 detects, from the map information, sign information set in a traveling position of the vehicle 10 and displays the sign information on a screen 16a.

The information terminal 114 is a terminal that can be carried into and carried out from the vehicle interior 12 and is connected to the terminal 10. Specifically, the information terminal 114 is a smartphone, a tablet terminal, or the like installed with application software for car navigation. The information terminal 114 is connected to a server 116 via a public line 118 and stores latest map information downloaded from the server 116 in a storage device on the inside. The information terminal 114 includes a function of positioning a traveling position of the vehicle 10. The information terminal 114 detects sign information set in the traveling position of the vehicle 10 from the map information and displays the sign information on a screen 114a.

### 6.2 Display Device

In the first to fourth embodiments, the MID 28 is used as the display device. However, other apparatuses can also be used instead of the MID 28. For example, a head-up display (HUD) 120, the car navigation apparatus 16, the information terminal 114, and the like shown in FIG. 12 can also be used.

### 6-3. Others

In the first to fourth embodiments, the school-zone maximum speed information is displayed laterally beside the normal maximum speed information. However, instead of the school-zone maximum speed information, maximum speed information under another limiting condition can also be displayed laterally beside the normal maximum speed information.

The school-zone maximum speed information can also be displayed vertically beside the normal maximum speed information, rather than laterally beside the normal maximum speed information.

What is claimed is:

1. A sign display apparatus for a vehicle comprising:
a sign information detector configured to detect sign information of a traffic sign existing along a road or on a road marking ahead of the vehicle;
a display device configured to display the sign information detected by the sign information detector; and
a control circuit configured to control the display device, to determine whether or not the sign information detector detects either or both of (i) first sign information indicating a first speed limit in a first section in which the first speed limit is considered to be effective and (ii) second sign information indicating a second speed limit in a second section in which the second speed limit is considered to be effective, and to determine whether or not the vehicle is traveling in the second section overlapping the first section, wherein
when it is determined that the sign information detector detects both the first sign information and the second sign information in the second section overlapping the first section, the display device is controlled to display the first sign information and the second sign information side by side.

2. The sign display apparatus for the vehicle according to claim 1, wherein
the display device displays the first sign information in a predetermined position on a display and does not display the second sign information when the sign information detector detects the first sign information, but does not detect the second sign information, and
the display device displays the first sign information in the predetermined position and displays the second sign information in a position lateral to the predetermined position when the sign information detector detects both the first sign information and the second sign information.

3. The sign display apparatus for the vehicle according to claim 2, wherein the display device is configured to display the second sign information in a manner that flashes the second sign information a predetermined number of times.

4. The sign display apparatus for the vehicle according to claim 1, further comprising a speed detector that detects speed of the vehicle, wherein
when the display device starts to display the second sign information, the display device displays the second sign information in a highlighting manner that makes the second sign information more visually prominent than the first sign information,
the display device again displays the second sign information in the highlighting manner, when the speed detected by the speed detector is continuously higher than the second speed limit indicated by the second sign information for a predetermined or longer time period or for a predetermined or longer distance.

5. The sign display apparatus for the vehicle according to claim 1, further comprising an obstacle detector that detects an obstacle around the vehicle, wherein
the second sign information indicates a school zone speed limit applied to a school-zone effective day and time for a school, a kindergarten, and a nursery school, and
the display device displays the second sign information in a highlighting manner that makes the second sign information more visually prominent than the first sign information, when the obstacle detector detects a predetermined or more number of obstacles around the vehicle.

6. The sign display apparatus for the vehicle according to claim 1, further comprising at least one of:
a calendar day detector that detects a current calendar day when the vehicle is traveling; and a time detector that detects current time when the vehicle is traveling, wherein
the second sign information indicates a school zone speed limit in a school-zone effective day and time for a school, a kindergarten, and a nursery school, and
when the sign information detector detects the second sign information, the display device is controlled to,
display the first sign information and the second sign information side by side if the current calendar day detected by the calendar day detector falls into the school-zone effective day or the current time detected by the time detector falls into the school-zone effective time, and
display only the first sign information if the current calendar day detected by the calendar day detection does not fall into the school-zone effective day or the current time detected by the time detector does not fall into the school-zone effective time.

7. A sign display method for the vehicle comprising:
detecting sign information of a traffic sign existing along a road or on a road marking ahead of the vehicle; and
determining whether or not the sign information represents either or both of (i) first sign information indicating a first speed limit in a first section in which the first speed limit is considered to be effective and (ii) second sign information indicating a second speed limit in a second section in which the second speed limit is considered to be effective and determining whether or not the vehicle is traveling in the second section overlapping the first section; and
displaying the first sign information and the second sign information side by side on a display when both the first sign information and the second sign information of second maximum speed are detected in the second section overlapping the first section.
